(19) United States
(12) Patent Application Publication
(10) Pub. No.: US 2015/0296064 A1
(43) Pub. Date: Oct. 15, 2015

(54) SUPPORTING TOOL FOR PORTABLE INFORMATION TERMINAL

(71) Applicant: MOGU Co., Ltd., Miki-shi, Hyogo (JP)

(72) Inventor: Yoshinobu ISHIDA, Toyonaka-shi (JP)

(21) Appl. No.: 14/443,224

(22) PCT Filed: May 15, 2013
(86) PCT No.: PCT/JP2013/063579

§ 371 Date: May 15, 2015

(30) Foreign Application Priority Data
Nov. 16, 2012 (JP) 2012-252229
Apr. 8, 2013 (JP) 2013-080569

(51) Int. Cl. H04M 1/04; G06F 1/16

(52) U.S. Cl. CPC H04M 1/04; G06F 1/1633

(57) ABSTRACT

The present invention provides a supporting tool for a portable information terminal that can freely and easily adjust a tilt angle.

The supporting tool for a portable information terminal includes a deformable bag body having particulate fillers enclosed in a bag; and an adhesion member mounted to the bag body so as to be capable of being adhesive to the portable information terminal, wherein
the supporting tool is configured to be capable of supporting the portable information terminal at various tilt angles with the bag body in a state in which the portable information terminal is directly adhesive to the adhesion member.

### TECHNICAL FIELD

The present invention relates to a supporting tool for a portable information terminal.

### BACKGROUND ART

A user can view a still image or a moving image searched via the Internet by using a portable information terminal of a touch panel type called “smartphone” or “tablet terminal”. A situation in which a user flatly lays a portable information terminal on a desktop for looking into the portable information terminal to view an image causes a trouble such that the user is difficult to view an image due to a reflection of light from an illumination on a ceiling of a room on a screen or a trouble such that the user retaining a position for looking into the portable information terminal for a long time becomes tired. For these troubles, a stand that is mounted to a back surface of a portable information terminal to prop up the portable information terminal on a desktop is frequently used.

As a conventional stand for a smartphone, Patent Document 1 proposes a stand including a stand body with a shape of cartoon characters, dolls, vehicles, buildings, tools, vegetables, fruits, or animals; and a sucker mounted to the stand body. This stand is configured to fix Page 3 the stand body to a smartphone with the sucker being adhered to the back surface of the smartphone, and to support the smartphone at a tilt angle of almost right angle (about 60 to 80 degrees relative to a horizontal plane) with the stand body.

Patent Document 1 also describes that a soft gel-like resin plate may be used instead of the sucker. In this case, the smartphone can be supported with large friction force between the soft gel-like resin plate and the back surface of the smartphone.

Patent Document 1 does not describe a material of the stand body and an internal structure. However, it is predicted that the stand body has rigidity or resistance to compressive strength so as to be capable of supporting the smartphone without being crushed by the smartphone.

As a conventional stand for a tablet terminal, Patent Document 2 proposes a stand functioning as a protection cover, when the tablet terminal is not used. This stand includes openable first and second protect boards that are coupled to each other, wherein the first protect board has one groove-like bent portion in a lateral direction, and the second protect board has a plurality of horizontal positioning grooves.

In order to prop up a tablet terminal with the stand in Patent Document 2, the bent portion of the first protect board is bent to allow the tablet terminal to lean, and the lower end of the tablet terminal is fitted to any one of the positioning grooves of the second protect board. With this, the tablet terminal is supported with a predetermined tilt angle. In this case, the tilt angle of the tablet terminal can be adjusted stepwise by the selection of the positioning groove.

Further, as a conventional stand for a tablet terminal, Patent Document 3 proposes a cushion body having a frame-like pocket that stores a tablet terminal. Particulate fillers are filled in the cushion body, and the cushion body is freely deformed with the movement of the fillers, whereby the tilt angle of the tablet terminal can be adjusted in a stepless manner.

Notably, a plurality of manufacturers sell tablet terminals with various screen sizes (e.g., 5.0 inches, 5.5 inches, 7.0 inches, 7.7 inches, 7.9 inches, 8.9 inches, 9.4 inches, 9.7 inches, 10.0 inches, 10.1 inches, and the like), and even if the screen size is the same, an outer dimension is different for each manufacturer. Therefore, the frame-like pocket in the cushion body in Patent Document 3 is formed for an outer dimension of a specific tablet terminal.

### PRIOR ART DOCUMENTS

### Patent Documents

Patent Document 1: Japanese Utility Model No. 3176522

Patent Document 2: Japanese Utility Model No. 3164648

Patent Document 3: Australian Design Number 201211643

### SUMMARY OF THE INVENTION

### Problems to be Solved by the Invention

When a user views an image on a smartphone, he/she often views the image with his/her face close to a screen of the smartphone propped up on a desktop such as a desk in an office or a table in a dining room, because the screen of the smartphone is small. When the smartphone is leaned against the stand with a sucker described in Patent Document 1, the tilt angle of the smartphone becomes an almost right angle (60 to 80 degrees) as described above. Therefore, when the smartphone is moved close to the user, the user views the screen from diagonally above, which brings difficulty in viewing. However, the tilt angle of the smartphone cannot be adjusted with the stand having the sucker in Patent Document 1. Accordingly, the user views the screen of the smartphone from front with the position in which his/her eyes are lowered down, and this makes it difficult to view the screen in a comfortable position with a straight back. When the stand having the soft gel-like resin plate in Patent Document 1 is used, it is predicted that the stand falls down with the portable information terminal, because the lower end of the portable information terminal slips on the desktop in an action of decreasing the tilt angle of the portable information terminal.

When a user views an image on a tablet terminal, he/she often views the image on the tablet terminal propped up on a low table in a living room, sitting on a sofa, because the screen of the tablet terminal is relatively large. In this case, when the stand in Patent Document 2 is used, the tilt angle of the tablet terminal cannot finely be adjusted to an angle desired by the user. Therefore, the tilt angle of the tablet terminal cannot finely be adjusted to an angle by which the user can easily view according to his/her position on the sofa, for example, a slouching position, a sitting-back position, or a lying position.

On the other hand, when the cushion body in Patent Document 3 is used, the tilt angle of the tablet terminal can be finely adjusted to an angle by which the user can easily view. However, the size of the frame-like pocket of the cushion body is adapted to an outer size of a specific tablet terminal. Therefore, another tablet terminal having a size larger than the size of the frame-like pocket cannot be stored, while another tablet terminal smaller than the size of the frame-like pocket might fall down to the outside from the opening of the frame-like pocket. When a user has a plurality of tablet terminals with different outer sizes, the user has to buy all cushion bodies for each of the outer sizes of the tablet terminals, which is uneconomical.

The present invention is accomplished in view of the above problems, and aims to provide a supporting tool for a portable information terminal that can be used for any portable information terminals with various outer sizes, and can freely and easily adjust a tilt angle only when a user places a portable information terminal thereon.

### Solution to the Problems

Accordingly, the present invention provides a supporting tool for a portable information terminal, the supporting tool including: a deformable bag body having particulate fillers enclosed in a bag; and an adhesion member mounted to the bag body so as to be capable of being adhesive to the portable information terminal,

the supporting tool is configured to be capable of supporting the portable information terminal at various tilt angles with the bag body in a state in which the portable information terminal is directly adhesive to the adhesion member.

### Effect of the Invention

In the supporting tool for a portable information terminal according to the present invention, the bag body having particulate fillers enclosed therein can freely be deformed like a cushion. In this case, the bag body having particulate fillers enclosed therein can freely be deformed, whatever three-dimensional shape the bag body has. With this, the supporting tool can support the portable information terminal at various tilt angels with the bag body in a state in which the portable information terminal is directly adhesive to the adhesion member.

Specifically, with the supporting tool according to the present invention, a user can freely and finely adjust the tilt angle of the portable information terminal in a stepless manner, and can feely tilt the portable information terminal throughout the entire circumference of the supporting tool, only by placing the portable information terminal onto the supporting tool.

Since the supporting tool according to the present invention can stably support the portable information terminal, a user can operate a touch panel with the portable information terminal being placed onto the supporting tool.

The supporting tool has a simple configuration, thereby being capable of being produced with low cost.

### BRIEF DESCRIPTION OF THE DRAWINGS

FIG. 1 illustrates an embodiment 1 of a supporting tool for a portable information terminal according to the present invention, wherein (A) is a plan view, (B) is a front view, and (C) is a bottom view.

FIG. 2 is an explanatory view illustrating a state in which the supporting tool according to the embodiment 1 is attached to a back surface of a smartphone.

FIG. 3 is an explanatory view illustrating a state in which the smartphone is propped up on a desk in an office with the supporting tool according to the embodiment 1.

FIG. 4 is a view for describing a state of use of the supporting tool according to the embodiment 1, wherein (A) illustrates a state in which the smartphone is vertically placed, and (B) illustrates a state in which the smartphone is horizontally placed.

FIG. 5 is a view for describing that the supporting tool according to the embodiment 1 can support the smartphone such that the smartphone is tilted in any directions.

FIG. 6 is an explanatory view illustrating a state in which a user holds the smartphone with his/her left hand via the supporting tool according to the embodiment 1.

FIG. 7 is a front view of a supporting tool according to an embodiment 2.

FIG. 8 is a front view of a supporting tool according to an embodiment 3.

FIG. 9 is a front view of a supporting tool according to an embodiment 4.

FIG. 10 illustrates a supporting tool according to an embodiment 5, wherein (A) is a plan view, (B) is a front view, and (C) is a bottom view.

FIG. 11 is an explanatory view illustrating a state in which a tablet terminal is propped up on a table in a living room with the supporting tool in the embodiment 5.

FIG. 12 illustrates a supporting tool according to an embodiment 6, wherein (A) is a plan view, (B) is a front view, and (C) is a bottom view.

FIG. 13 is a view for describing that the supporting tool according to the embodiment 6 can support the smartphone such that the smartphone is tilted in any directions.

FIG. 14 illustrates a supporting tool according to an embodiment 7, wherein (A) is a plan view, (B) is a front view, and (C) is a bottom view.

FIG. 15 is a view illustrating a supporting tool according to an embodiment 8, wherein (A) is for a smartphone, and (B) is for a tablet terminal.

FIG. 16 is a view illustrating a supporting tool according to an embodiment 9, wherein (A) is for a smartphone, and (B) is for a tablet terminal.

FIG. 17 is a view illustrating a supporting tool according to an embodiment 10, wherein (A) is for a smartphone, and (B) is for a tablet terminal.

FIG. 18 is a view illustrating a supporting tool according to an embodiment 11, wherein (A) is for a smartphone, and (B) is for a tablet terminal.

FIG. 19 is a view illustrating a supporting tool according to an embodiment 12, wherein (A) is for a smartphone, and (B) is for a tablet terminal.

FIG. 20 is a view illustrating a supporting tool according to an embodiment 13, wherein (A) is for a smartphone, and (B) is for a tablet terminal.

FIG. 21 is a view illustrating a supporting tool according to an embodiment 14, wherein (A) is a plan view, (B) is a front view, and (C) is a bottom view.

FIG. 22 is a view illustrating a supporting tool according to the embodiment 12, wherein (A) illustrates a state in which the bag body is stretched in four directions to be expanded, and (B) illustrates a state in which a tablet terminal is supported upright on a desktop.

### EMBODIMENTS OF THE INVENTION

A supporting tool for a portable information terminal includes a deformable bag body having particulate fillers enclosed in a bag; and an adhesion member mounted to the bag body so as to be capable of being adhesive to the portable information terminal, the supporting tool being configured to be capable of supporting the portable information terminal at various tilt angles with the bag body in a state in which the portable information terminal is directly adhesive to the adhesion member.

In the present invention, the bag of the bag body is not particularly limited. For example, a bag made of a textile fabric or a knitting fabric, a bag made of a plastic sheet, or a net bag can be used for the bag.

Particulate fillers such as foamed resin particles, glass beads, plastic beads, buckwheat chaff, wood pellets, pebbles, and sand are used for the fillers.

Among these, a bag body containing particulate fillers filled in a bag made of a textile fabric or a knitting fabric is preferable, since it can easily be deformed, can easily maintain a deformed state, and provides satisfactory feeling. Especially, a bag body containing foamed resin particles (e.g., foamed polystyrene resin particles) in a bag made of a cloth with stretch properties is noticeable, and it can increase a degree of freedom in designing a three-dimensional shape of a bag body.

In the present invention, the adhesion member allows the bag body to be adhesive to a metallic or plastic back surface of the portable information terminal without being displaced, when the portable information terminal is supported by the supporting tool.

For example, a sucker member or an antislip sheet material can be used as the adhesion member. Examples of suitable materials for the antislip sheet material include elastomer (various rubbers) having excellent antislip property and foamed resin. For example, a silicone rubber or foamed polyvinyl chloride resin is preferable.

If a sucker member is used as the adhesion member, the bag body can detachably be fixed to the back surface of the portable information terminal, and further, the portable information terminal can be used with the supporting tool being always attached thereto. A supporting tool with a sucker member is suitably used, when a portable information terminal is a multifunction cellular phone (hereinafter referred to as a “smartphone”) of a touch panel type.

If an antislip sheet material is used as the adhesion member, the portable information terminal can lean against the bag body without being displaced due to friction force between the antislip sheet material and the back surface of the portable information terminal. A supporting tool with an antislip sheet material is suitably used, when the portable information terminal is a tablet terminal of a touch panel type.

In addition, in the supporting tool according to the present invention, the bag body may have a cleaning sheet material and/or an antislip member at a position opposite to the position of the adhesion member.

The bag body may also have four loop portions that are to be hooked to four corners of the tablet terminal. When the four loop portions of the bag body are hooked to four corners of the tablet terminal, the tablet terminal is held from the back surface by the supporting tool, whereby the tablet terminal can be held upright with the supporting tool on a desktop.

Hereinafter, embodiments of the supporting tool for a portable information terminal according to the present invention will be described with reference to the drawings.

### Embodiment 1

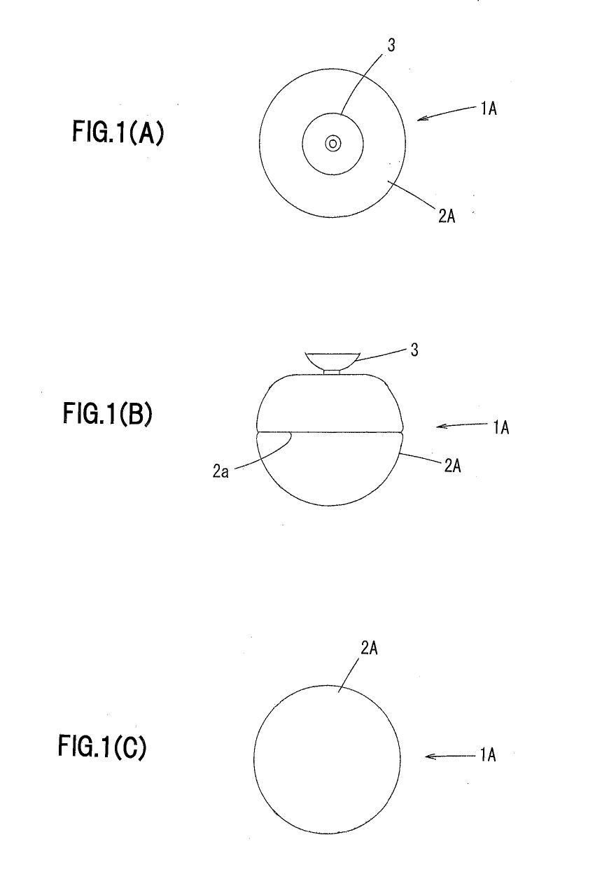

FIG. 1 illustrates an embodiment 1 of a supporting tool for a portable information terminal according to the present invention, wherein (A) is a plan view, (B) is a front view, and (C) is a bottom view.

The embodiment 1 illustrates a supporting tool 1A for a smartphone. This supporting tool 1A includes an approximately spherical deformable bag body 2A containing particulate fillers filled in a bag, and a sucker member 3 mounted to the bag body 2A as an adhesion member.

The bag body 2A suitably has a size with a volume of about 15 to 180 cm³.

The bag forming the bag body 2A is formed by sewing two circular cloths, for example. Considering the size of the bag body 2A, the size of each cloth can be about 4 to 8 cm in diameter. In this connection, a reference numeral 2a indicates a seam in FIG. 1(B).

The cloth of the bag of the bag body 2A is not particularly limited, so long as it has a texture or a stitch through which the particulate fillers do not pass. However, the cloth preferably has stretch properties from the viewpoint of enhancing deformability of the bag body 2A. For example, a cloth having stretch properties of 30 to 300% in a stretch test can be used as the cloth having stretch properties, and Spandex (polyurethane elastic yarn) having elasticity can specifically be used. In this connection, a part of the bag may be made of a cloth having stretch properties.

The particulate fillers in the bag body 2A are not particularly limited, so long as they do not pass through the texture or stitch of the cloth of the bag. Examples of the particulate fillers include foamed resin particles, glass beads, plastic beads, buckwheat chaff, wood pellets, pebbles, and sand. Among these materials, foamed resin particles are preferable, since they can implement a light-weight bag body 2A, can suppress repulsive force of the bag body 2A to provide excellent deformability and feeling of the bag body 2A, and is available with relatively low cost. Specifically, foamed polystyrene resin particles with an average particle diameter of about 0.3 to 3.0 mm are preferable for the foamed resin particles.

Upon producing a bag by sewing two cloths, a portion that is not sewed may be left to form a filling opening from which the fillers are filled later, a nozzle may be inserted into the filling opening to fill the fillers in the bag, and then, the filling opening may be closed. Also, a filling opening with a short tubular form may be formed on the bag, and this structure facilitates the closing of the filling opening after the fillers are filled. Although a protruding portion remains on the bag in this case, this protruding portion may be pushed into the bag body 2A.

A commercially available product having a sucker portion with a diameter of about 2 to 6 cm can be used as the sucker member 3, for example. The sucker member 3 has a protrusion at a center of a convex curve surface of the sucker portion, and is sewed such that this protrusion is buried in the bag body 2A. In this case, the protrusion of the sucker portion 3 is sewed on the central position of one of two circular cloths forming the bag body 2A. In this connection, the sucker member 3 may be sewed on one of the cloths which are not yet made into the bag.

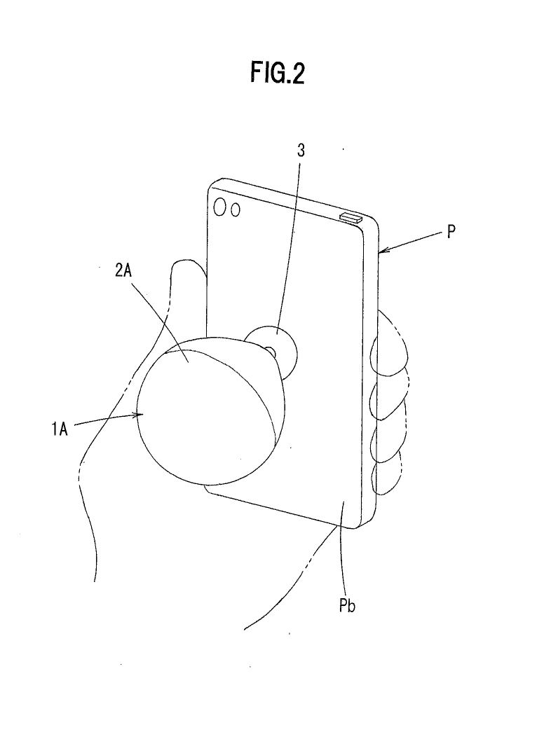

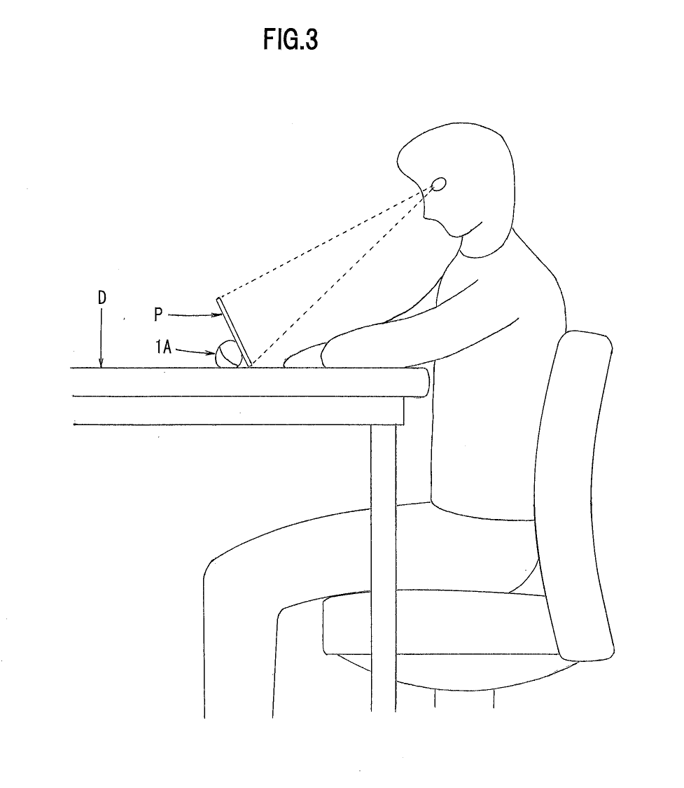

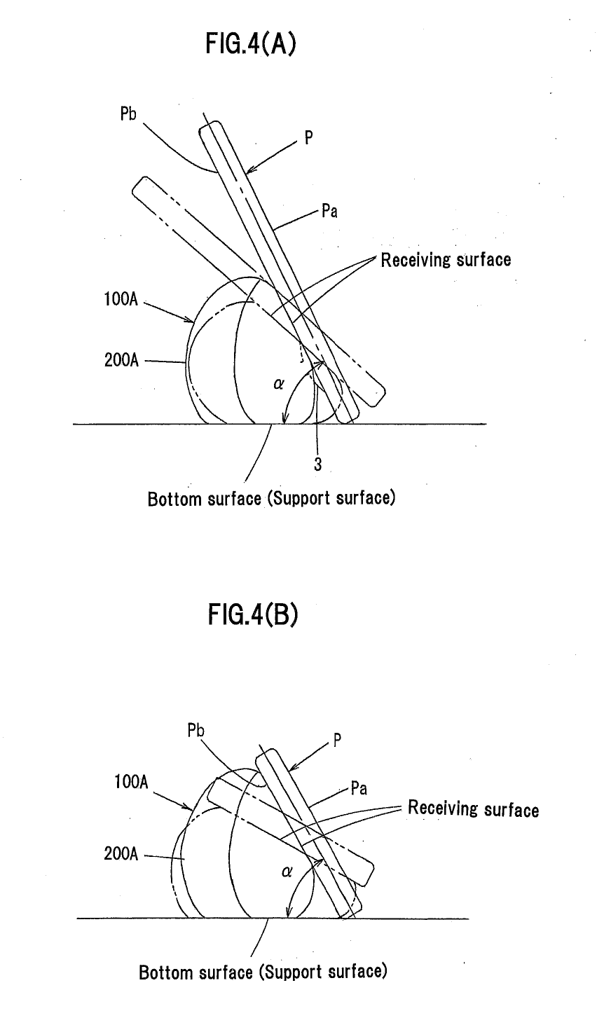

FIG. 2 is an explanatory view illustrating a state in which the supporting tool 1A according to the embodiment 1 is attached to a back surface Pb of a smartphone P, and FIG. 3 is an explanatory view illustrating a state in which the smartphone P is propped up on a desk D in an office with the supporting tool 1A according to the embodiment 1. FIG. 4 is a view for describing a state of use of the supporting tool 1A according to the embodiment 1, wherein (A) illustrates a state in which the smartphone P is vertically placed, and (B) illustrates a state in which the smartphone P is horizontally placed.

When a user props up the smartphone P on the desk D by using the supporting tool 1A according to the embodiment 1, he/she allows the sucker member 3 to be adhered on (allows the sucker member 3 to be adhesive to) the flat back surface Pb of the smartphone P as illustrated in FIG. 2. Then, as illustrated in FIG. 3, the user puts the smartphone P onto the desk D such that the smartphone P leans against the supporting tool 1A.

In this case, the sucker member 3 is adhered to a position based on the direction and the tilt angle of the smartphone P. When the smartphone P is vertically placed, for example, the sucker member 3 is adhered to a lower end position of the back surface Pb of the smartphone P, whereby the smartphone P can easily be supported by the bag body 2A with a tilt angle α being relatively increased, as illustrated in FIG. 4(A). In FIG. 4(A), since the bag body 2A is deformed by the smartphone P pressed against the bag body 2A as indicated by a two-dot chain line, the tilt angle α can easily be adjusted to be small. The tilt angle α can also be adjusted to be larger than the tilt angle α of the smartphone P indicated by a solid line in FIG. 4(A).

When the smartphone P is horizontally placed, for example, the sucker member 3 is adhered to a center position of the back surface Pb of the smartphone P, whereby the smartphone P can easily be supported by the bag body 2A with a tilt angle α being relatively increased, as illustrated in FIG. 4(B). In FIG. 4(B), the smartphone P pressed against the bag body 2A as indicated by a two-dot chain line, the tilt angle α can easily be adjusted to be small. The tilt angle α can also be adjusted to be larger than the tilt angle α of the smartphone P indicated by a solid line in FIG. 4(B).

As described above, according to the supporting tool 1A of the embodiment 1, the smartphone P can be supported vertically or horizontally, and further, the user can finely adjust the tilt angle in a stepless manner to the tilt angle α by which the user can easily see a screen (front surface Pa) of the smartphone P only by placing the smartphone P with the supporting tool 1A onto a desktop. Further, the supporting tool 1A according to the embodiment 1 can support the smartphone P such that the smartphone P is tilted in any directions as illustrated in FIG. 5.

More specifically described, according to the supporting tool 1A of the embodiment 1, the bag body 2A containing the particulate fillers inside can freely be deformed like a cushion. With this, when the supporting tool 1A supports the smartphone P on a desktop such as a desk, a receiving surface is formed on the contact portion between the bag body 2A and the smartphone P due to the weight of the smartphone P, and a bottom surface (support surface) is formed between the bag body 2A and the desktop, as illustrated in FIGS. 4(A) and 4(B). Thus, the smartphone P can be supported with the bag body 2A in any directions at various tilt angles with the sucker member 3 adhered to the back surface of the smartphone P as illustrated in FIG. 5.

In this case, even if the bag body 2A has a three-dimensional shape with a projecting portion such as a top portion, a corner, or a protrusion as illustrated in later-described embodiments 6 to 13, the smartphone P can be supported with the bag body 2A in any directions at various tilt angles, because the projecting portion is buried to form a receiving surface or a bottom surface (support surface). Specifically, in the supporting tool according to the present invention, the three-dimensional shape of the bag body is not limited, but can freely be designed. The effect provided by such configuration becomes noticeable when the bag body 2A is formed by using a bag made of a stretchable cloth.

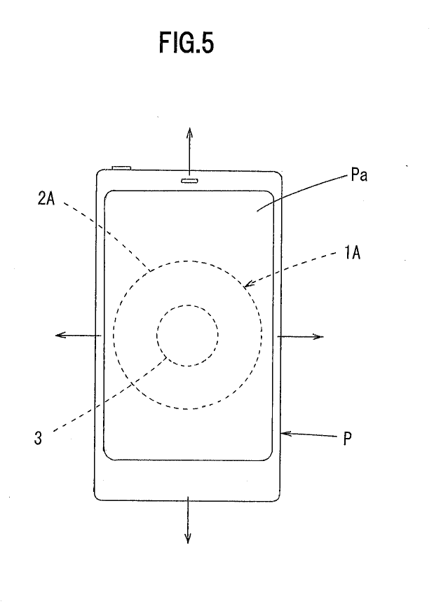

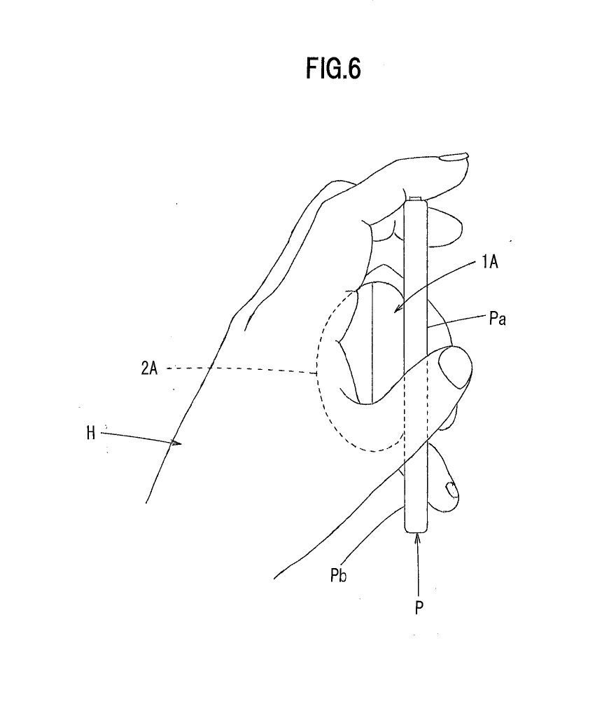

FIG. 6 is an explanatory view illustrating a state in which a user holds the smartphone P with his/her left hand via the supporting tool 1A.

When the user picks up the smartphone P propped up on a desktop with the supporting tool 1A with his/her left hand H, and operates a touch panel with his/her right hand, the supporting tool 1A adhered to the smartphone P does not interfere. Specifically, as illustrated in FIG. 6, the bag body 2A is fitted between the palm of the left hand H and the back surface Pb of the smartphone P, and this prevents the user from having an uncomfortable feeling even if he/she grips an outer periphery of the smartphone P with five fingers of the left hand H.

In addition, this state is convenient, since the user can stably grip the smartphone P with the left hand H. Further, a finger pressure upon the operation of the touch panel of the smartphone P is appropriately released due to cushion properties of the bag body 2A, which can protect the touch panel from excessive finger pressure. Accordingly, the supporting tool 1A may be kept always adhered to the smartphone P, and this state can prevent the supporting tool 1A from missing.

### Embodiment 2

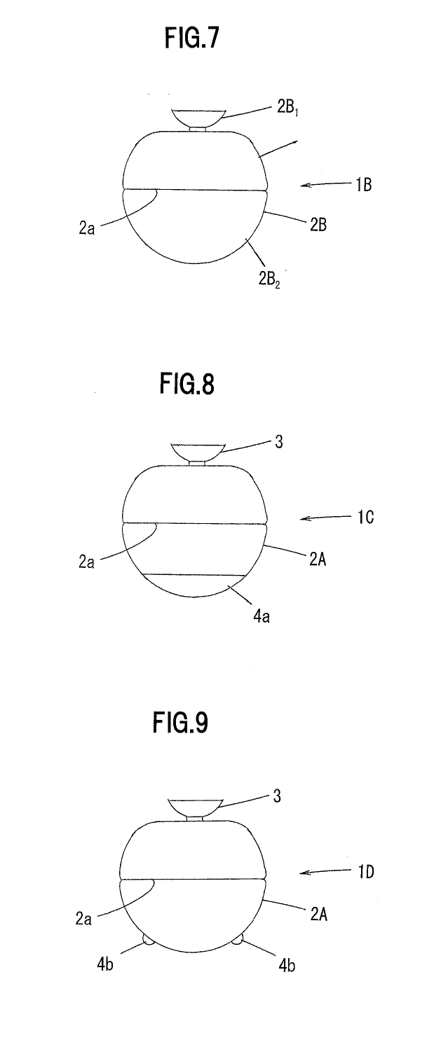

FIG. 7 is a front view of a supporting tool according to an embodiment 2. In FIG. 7, components same as those in FIGS. 1 to 6 are identified by the same reference numerals.

Similar to the embodiment 1, a supporting tool 1B according to the embodiment 2 includes a bag body 2B containing particulate fillers filled inside, and a sucker member 3 mounted to the bag body 2B, but a bag forming the bag body 2B is different from the embodiment 1.

In the embodiment 2, the bag of the bag body 2B is formed by sewing a cloth 2B₁ to which the sucker member 3 is mounted and the other cloth 2B₂ to which the sucker member 3 is not mounted. The cloth 2B₁ has stretch properties as in the embodiment 1, while the other cloth 2B₂ is made of a cleaning sheet. A commercially available cleaning sheet for removing fingerprints, dirt from hands, oil, and the like deposited on a touch panel of a smartphone or a tablet terminal can be used for this cleaning sheet.

The supporting tool 1B according to the embodiment 2 can be used for supporting the smartphone on a desktop, and further, can be used to clean the touch panel of the smartphone with a cleaning sheet material (cloth 2B₂) of the supporting tool 1B when the smartphone is not propped up on the desktop. Notably, a cleaning sheet may be sewed or adhered to a part of the bag that is entirely made of a stretchable cloth described in the embodiment 1.

### Embodiment 3

FIG. 8 is a front view of a supporting tool according to an embodiment 3. In FIG. 8, components same as those in FIGS. 1 to 6 are identified by the same reference numerals.

A supporting tool 1C according to the embodiment 3 includes the bag body 2A and the sucker member 3 used in the embodiment 1, but it is different from the embodiment 1 in that an antislip sheet material 4a serving as an antislip member is mounted to the bag body 2A.

The antislip sheet material 4a is made of elastomer (various rubbers) or foamed resin having excellent antislip property. For example, a silicone rubber sheet or a foamed polyvinyl chloride resin sheet is used, and they are commercially available. The embodiment 3 illustrates the case in which a circular antislip sheet material 4a is attached or sewed to one of the circular cloths which are not yet made into the bag. However, the shape of the antislip sheet material 4a is not particularly limited. In this connection, the sucker member 3 is mounted to the other circular cloth which is not yet made into the bag.

The supporting tool 1C according to the embodiment 3 can prevent the bag body 2A from slipping on the desktop with the antislip sheet material 4a when the smartphone is supported on the desktop, thereby being capable of stably supporting the smartphone on the desktop.

### Embodiment 4

FIG. 9 is a front view of a supporting tool according to an embodiment 4. In FIG. 9, components same as those in FIGS. 1 to 6 are identified by the same reference numerals.

A supporting tool 1D according to the embodiment 4 uses a plurality of antislip semispherical members 4b instead of the antislip sheet material 4a (see FIG. 8) used in the embodiment 3. The other configuration in the embodiment 4 is the same as the embodiment 3.

The material of the antislip semispherical members 4b can be the same as the material of the antislip sheet material 4a used in the embodiment 3. A commercially available product with a diameter of about 2 to 10 mm can be used as the antislip semispherical members 4b.

Similar to the embodiment 3, the supporting tool 1D according to the embodiment 4 can provide an antislip effect for the bag body 2A with the antislip semispherical members 4b.

### Embodiment 5

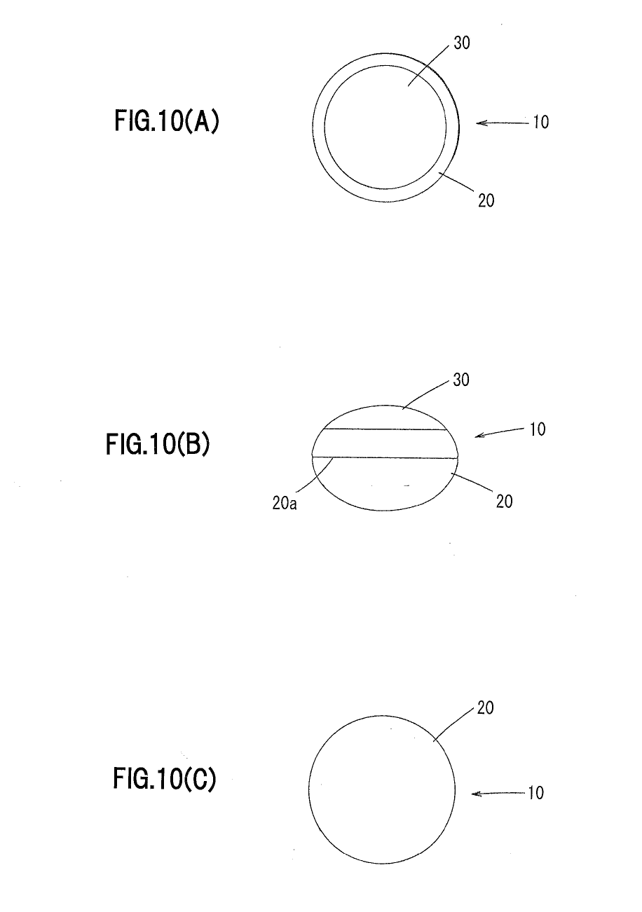

FIG. 10 illustrates a supporting tool according to an embodiment 5, wherein (A) is a plan view, (B) is a front view, and (C) is a bottom view. In FIG. 10(B), a reference numeral 20a represents a seam.

The embodiment 5 illustrates the supporting tool 10 for a tablet terminal. This supporting tool 10 includes a deformable bag body 20 having fillers enclosed in a round shaped bag, and an antislip sheet material 30 mounted to the bag body 20 as an adhesion member.

In the embodiment 5, a cloth forming the bag body 20 and fillers can be made of the materials same as those in the embodiment 1. However, in the embodiment 5, the bag body 20 appropriately has a size with a volume of about 180 to 4200 cm³ depending on the size of the tablet terminal, so that the appropriate size of the cloth is about 8 to 20 cm in diameter.

The antislip sheet material 30 is formed by cutting a silicone rubber sheet into a circle, and it is attached to one of the circular cloths, which are not yet made into a bag, with an adhesive. In this case, an appropriate diameter of the antislip sheet material 30 is 5 to 15 cm. In this connection, the shape of the antislip sheet material 30 is not particularly limited. The antislip sheet material 30 may have various shapes other than a circle, for example, a polygon such as a triangle, a rectangle, or a pentagon; an ellipse; a gourd shape; a heart shape; a star shape; or an outline of animals or cartoon characters.

In addition to the function as an antislip member adhesive to the back surface of the tablet terminal, the antislip sheet material 30 may have a function as a label displaying pictures, characters, symbols, graphics, logos, and the like. In this case, a transparent antislip material (e.g., transparent silicone resin) is coated on a printing surface of a resin sheet (e.g., polyester resin sheet) on which pictures, characters, symbols, graphics, logos, and the like are printed to prepare an antislip sheet material, and this antislip sheet material is thermally compressed (fused) to one of the cloths which are not yet made into the bag. If such antislip sheet material is used for the supporting tool 10, the supporting tool 10 can be utilized as promotion goods of companies. In this connection, the antislip sheet material 4a (see FIG. 8) in the previously described embodiment 3 may be formed as described above.

FIG. 11 is an explanatory view illustrating a state in which a tablet terminal J is propped up on a table T in a living room with the supporting tool 10 in the embodiment 5. FIG. 11 illustrates the case in which the tablet terminal J is vertically placed. However, the same shall apply to the case where the tablet terminal J is horizontally placed.

When a user views a moving image on the tablet terminal J while sitting on a sofa S in a living room, he/she props up the tablet terminal J on a low table T in the living room. In this case, the user places the supporting tool 10 according to the embodiment 5 on the table T, and sets the tablet terminal J against the supporting tool 10. This enables the supporting tool 10 to support the tablet terminal J with a predetermined tilt angle α. In this case, the antislip sheet material 30 is adhesive to a back surface Jb of the tablet terminal J, whereby positional deviation between the tablet terminal J and the antislip sheet material 30 does not occur.

In addition, as indicated by a two-dot chain line in FIG. 11, the user can easily adjust the tilt angle α to be small by pressing the tablet terminal J against the bag body 20. The user can also adjust the tilt angle to be larger than the tilt angle α of the tablet terminal J indicated by a solid line in FIG. 11. Specifically, the user can adjust the tilt angle α in a stepless manner only by replacing the tablet terminal J on the bag body 20.

As described above, with the supporting tool 10 according to the embodiment 5, the user can view the screen from front, even if the position of eyes of a viewer (user) U becomes much higher than the position of the screen (front surface Ja) of the tablet terminal J. Further, as described with reference to FIG. 5, the supporting tool 10 according to the embodiment 2 can support the tablet terminal J such that the tablet terminal J is tilted in any directions.

### Embodiment 6

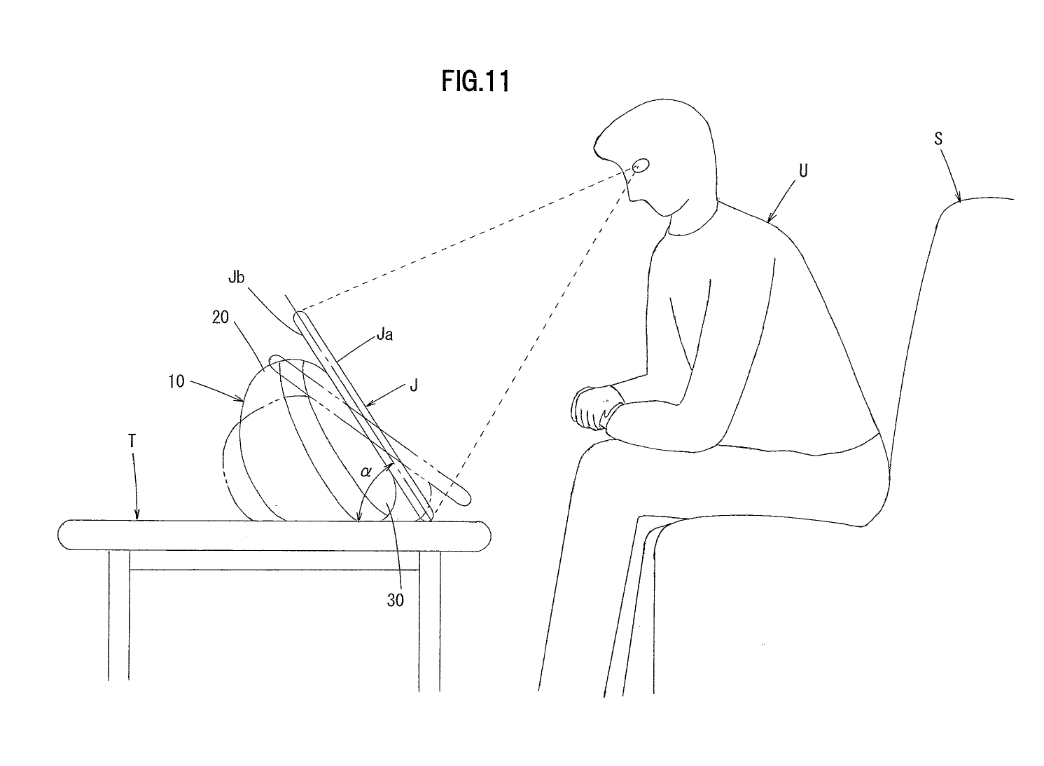

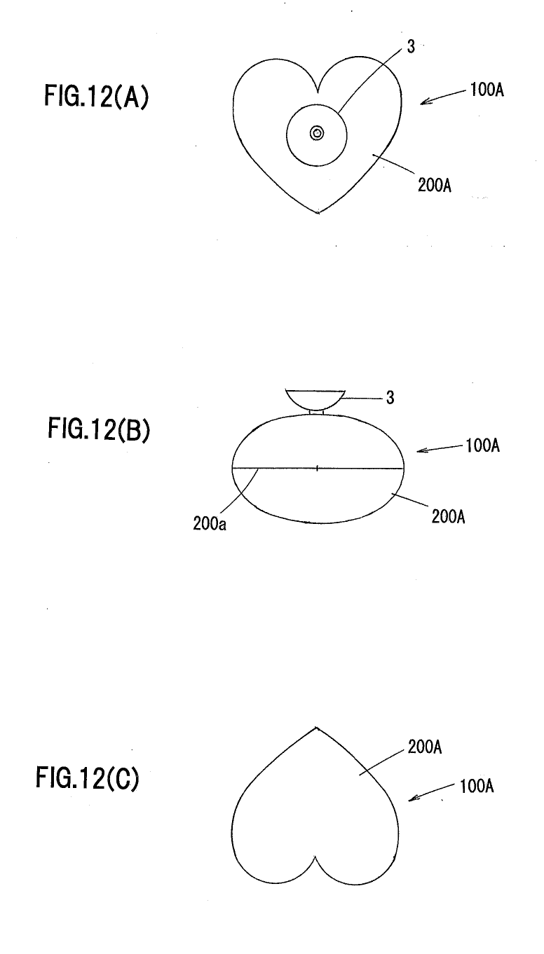

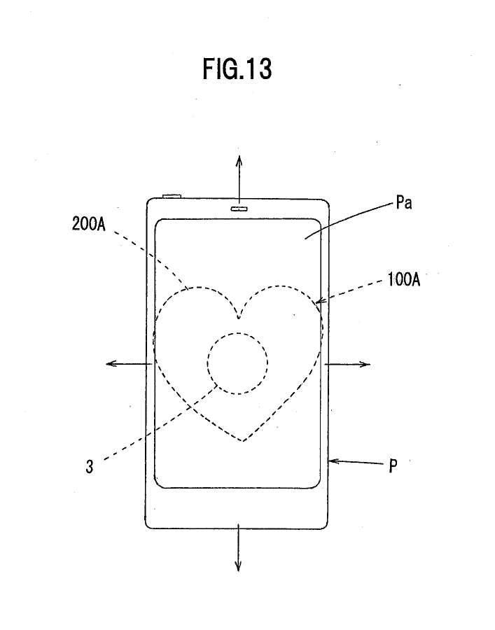

FIG. 12 illustrates a supporting tool for a portable information terminal according to an embodiment 6, wherein (A) is a plan view, (B) is a front view, and (C) is a bottom view. FIG. 13 is a view describing that the supporting tool according to the embodiment 6 can support a smartphone such that the smartphone is tilted in any directions.

The embodiment 6 illustrates a supporting tool 100A for a smartphone. This supporting tool 100A includes a deformable bag body 200A containing particulate fillers filled in a heart-shaped bag, and a sucker member 3 mounted to the bag body 200A as an adhesion member. A shape of the bag body 200A viewed from a front surface (FIG. 12(A)) or a back surface (FIG. 12(C)) is a heart, and a shape viewed from a side face (FIG. 12(B)) is an approximately circle including an ellipse or an oval. Specifically, the shape of the bag body 200A is a swelled heart.

The bag body 200A with a swelled heart shape has a top portion (projecting portion) at one part on its outer periphery. However, this top portion can be buried to form a bottom surface (support surface), when a smartphone P is supported by the supporting tool 100A as illustrated in FIG. 4(A) or 4(B).

Accordingly, with the supporting tool for a portable information terminal according to the present invention, the tilt angle of the smartphone P can freely and easily be adjusted in a stepless manner, as well as the smartphone P can freely be tilted throughout the entire circumference of the supporting tool 100A as illustrated in FIG. 13, as in the bag body 2A with an approximately spherical shape, even if the bag body 200A has a three-dimensional shape with a projecting portion.

### Embodiment 7

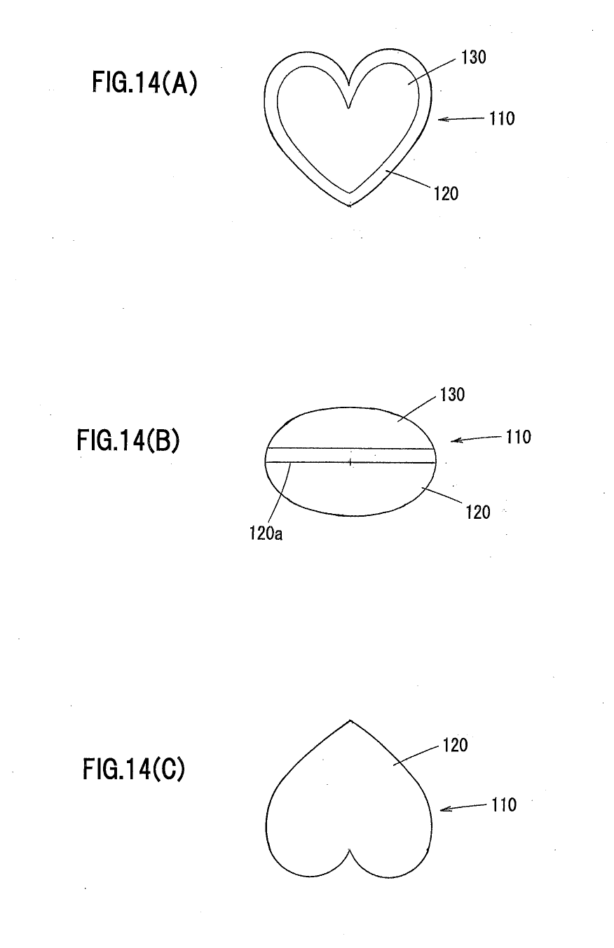

FIG. 14 illustrates a supporting tool according to an embodiment 7, wherein (A) is a plan view, (B) is a front view, and (C) is a bottom view. A reference numeral 120a indicates a seam.

The embodiment 7 illustrates a supporting tool 110 for a tablet terminal. This supporting tool 110 includes a deformable bag body 120 containing fillers filled in a bag with a swelled heart shape, and an antislip sheet material 130 mounted to the bag body 120 as an adhesion member. The supporting tool 110 according to the embodiment 7 is configured almost similar to the embodiment 5, except that the three-dimensional shape is different from the supporting tool 10 (see FIG. 10) according to the embodiment 5.

The bag body 120 with a swelled heart shape has a top portion (projecting portion) at one part on its outer periphery. However, this top portion can be buried to form a bottom surface (support surface), when a tablet terminal J is supported by the supporting tool 110 as illustrated in FIG. 11.

Accordingly, with this supporting tool 110, the tilt angle of the tablet terminal J can freely and easily be adjusted in a stepless manner, as well as the tablet terminal J can freely be tilted throughout the entire circumference of the supporting tool 110 as illustrated in FIG. 13, as in the bag body 20 with an approximately spherical shape, even if the bag body 120 has a three-dimensional shape with a projecting portion.

### Embodiment 8

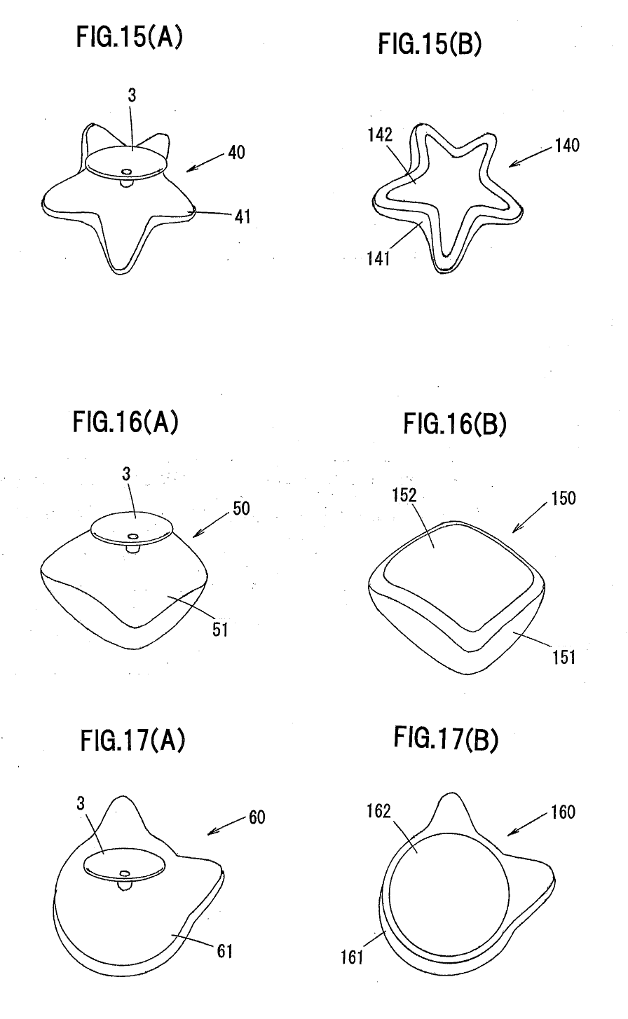

FIG. 15 is a view illustrating a supporting tool according to an embodiment 8, wherein (A) is for a smartphone, and (B) is for a tablet terminal.

A supporting tool 40 for a smartphone is configured such that a sucker member 3 is mounted to a front surface of a bag body 41 with a star shape.

A supporting tool 140 for a tablet terminal is configured such that an antislip sheet material 142 is attached to a front surface of a bag body 141 with a star shape.

### Embodiment 9

FIG. 16 is a view illustrating a supporting tool according to an embodiment 9, wherein (A) is for a smartphone, and (B) is for a tablet terminal.

A supporting tool 50 for a smartphone is configured such that a sucker member 3 is mounted to a front surface of a square bag body 51 containing particulate fillers filled in a square bag.

A supporting tool 150 for a tablet terminal is configured such that an antislip sheet material 152 is attached to a front surface of a square bag body 151.

### Embodiment 10

FIG. 17 is a view illustrating a supporting tool according to an embodiment 10, wherein (A) is for a smartphone, and (B) is for a tablet terminal.

A supporting tool 60 for a smartphone is configured such that a sucker member 3 is mounted to a front surface of a bag body 61 having an outline of an animal (e.g., cat) face.

A supporting tool 160 for a tablet terminal is configured such that an antislip sheet material 162 is attached to a front surface of a bag body 161 having an outline of an animal (e.g., cat) face.

### Embodiment 11

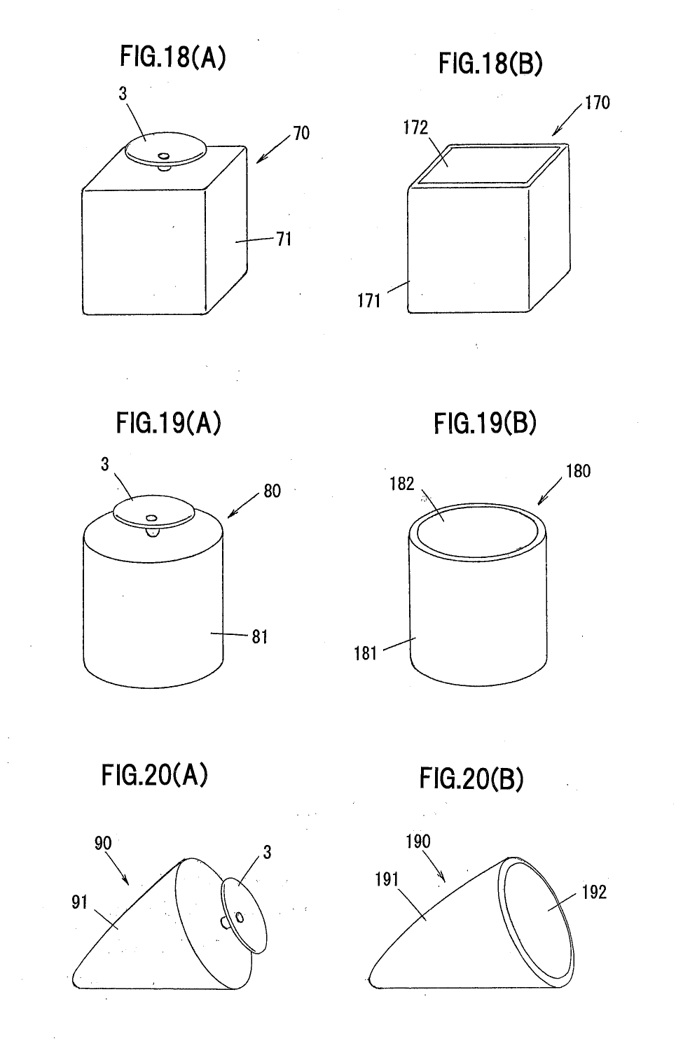

FIG. 18 is a view illustrating a supporting tool according to an embodiment 11, wherein (A) is for a smartphone, and (B) is for a tablet terminal.

A supporting tool 70 for a smartphone is configured such that a sucker member 3 is mounted to one surface of a cube bag body 71.

A supporting tool 170 for a tablet terminal is configured such that an antislip sheet material 172 is attached to one surface of a cube bag body 171.

### Embodiment 12

FIG. 19 is a view illustrating a supporting tool according to an embodiment 12, wherein (A) is for a smartphone, and (B) is for a tablet terminal.

A supporting tool 80 for a smartphone is configured such that a sucker member 3 is mounted on one end surface of a columnar bag body 81.

A supporting tool 180 for a tablet terminal is configured such that an antislip sheet material 182 is attached to one end surface of a cube bag body 181.

### Embodiment 13

FIG. 20 is a view illustrating a supporting tool according to an embodiment 13, wherein (A) is for a smartphone, and (B) is for a tablet terminal.

A supporting tool 90 for a smartphone is configured such that a sucker member 3 is mounted on a bottom part of a conic bag body 91.

A supporting tool 190 for a tablet terminal is configured such that an antislip sheet material 192 is attached to a bottom part of a conic bag body 191.

### Embodiment 14

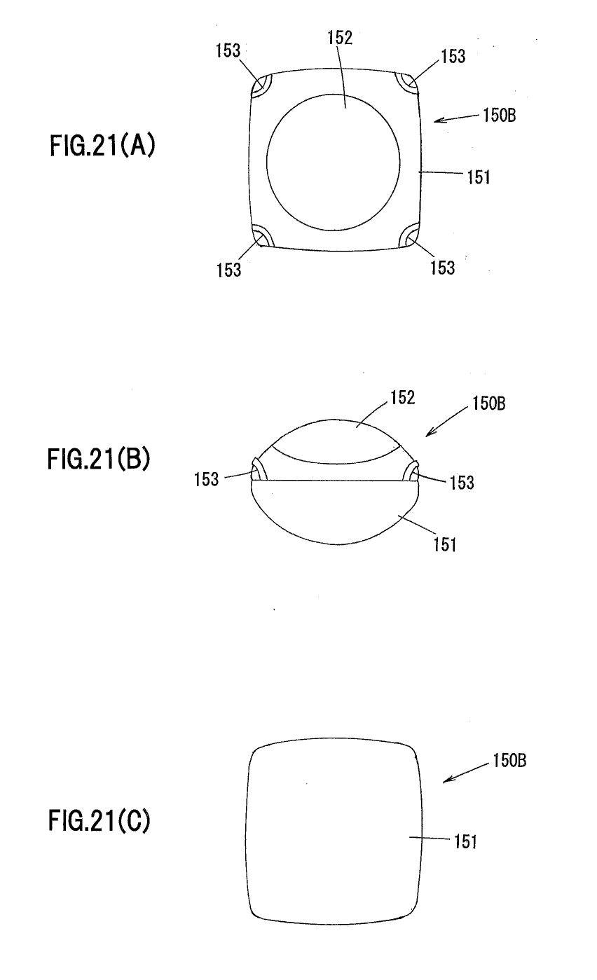

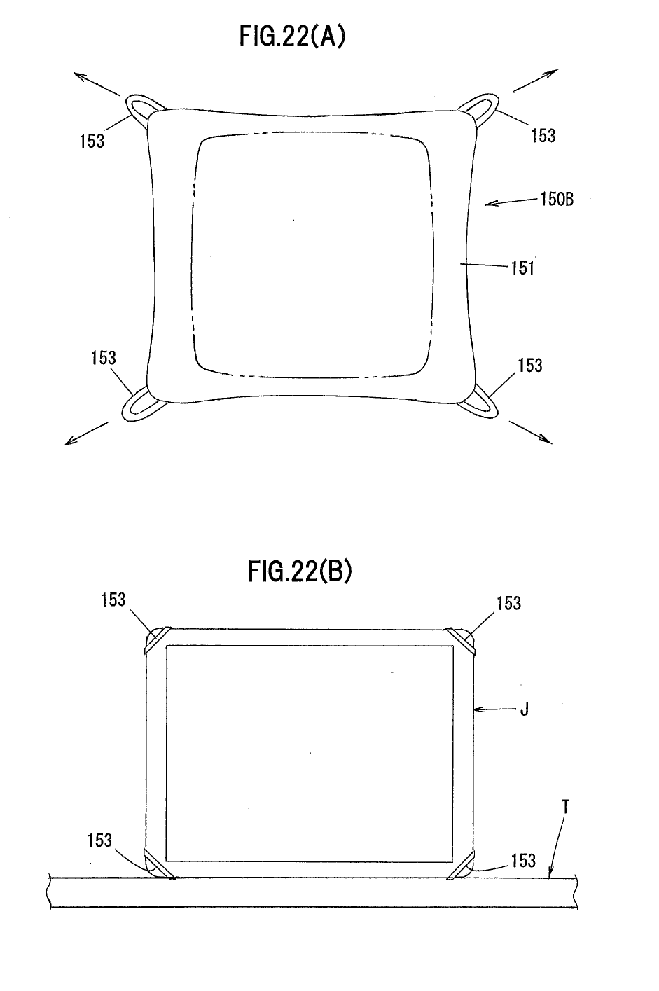

FIG. 21 is a view illustrating a supporting tool according to an embodiment 14, wherein (A) is a plan view, (B) is a front view, and (C) is a bottom view. FIG. 22 is a view for illustrating the supporting tool according to the embodiment 14, wherein (A) illustrates a state in which a bag body is stretched in four directions to be expanded, and (B) illustrates a state in which the supporting tool supports a tablet terminal upright on a desktop. In FIGS. 21 and 22, components same as those in FIG. 16(B) are identified by the same reference numerals.

A supporting tool 150B according to the embodiment 14 is formed by mounting loop portions 153 at four corners of the supporting tool 150 (see FIG. 16(B)) for a tablet terminal according to the embodiment 9. In this case, it is preferable that a bag of a bag body 151 is made of a cloth having stretch properties, or the loop portions 153 are made by using a string having stretch properties, or both of these structures are implemented. Further, a material same as the antislip sheet material 152 may be attached to an inner surface of the string forming the loop portions 153.

When the four loop portions 153 of the bag body 151 are pulled in four directions to be hooked to four corners of the tablet terminal J, the supporting tool 150B according to the embodiment 14 can hold the tablet terminal J from the back surface. Accordingly, the supporting tool 150B can hold the tablet terminal J upright on the table T. In this connection, a two-dot chain line in FIG. 22(A) indicates an outline of the bag body 151 before the four loop portions 153 are pulled.

With this supporting tool 150B, when the user views a moving image on a tablet terminal, lying on a sofa, for example, the user can turn his/her eyes to a vertical screen of the tablet terminal, whereby the user can view an appropriate image.

The bag body 151 in the supporting tool 150B according to the embodiment 14 can be expanded to a certain extent by a pulling action of the four loop portions 153 in four directions. Therefore, the supporting tool 150B can be used for any tablet terminals J with different sizes to some extent. The supporting tool 150B may be used in such a manner that each loop portion 153 is not hooked to each corner of the tablet terminal J.

### Other Embodiments

1. As in the embodiments 2 and 3 (FIGS. 7 and 8), the supporting tool 10 for a tablet terminal according to the embodiment 5 may have a cleaning sheet or an antislip sheet material at the position opposite to the position of the antislip sheet material 30 (adhesion member) on the bag 20.
2. The planar shape of the bag body is not limited to those in the above embodiments. Examples of the other shapes include a shape close to a circle, such as an ellipse, a chestnut shape, or a rugby-ball shape. In addition, a gather is formed on the seam portion of the bag body to form an outline of a face of an animal or a face of a cartoon character.
3. The loop portions described in the embodiment 12 are not limited to be formed on a square bag body, but may be formed on any bag bodies with various three-dimensional shapes.

### DESCRIPTION OF REFERENCE SIGNS

1A, 1B, 1C, 1D, 10, 40, 50, 60, 70, 80, 90, 100A, 100B, 100C, 100D, 110, 140, 150, 150B, 160, 170, 180, 190: Supporting tool

2A, 2B, 20, 41, 51, 61, 71, 81, 91, 141, 151, 161, 171, 181, 191, 200A, 200B, 120: Bag body

3: Sucker member (adhesion member)

4a: Antislip sheet material

4b: antislip semispherical member

30, 130, 142, 152, 162, 172, 182, 192, 400a: Antislip sheet material (adhesion member)
40: Antislip sheet material
J: Tablet terminal
Ja, Pa: Back surface
P: Smartphone

What is claimed is:

1. A supporting tool for a portable information terminal, the supporting tool comprising: a deformable bag body having particulate fillers enclosed in a bag; and an adhesion member mounted to the bag body so as to be capable of being adhesive to the portable information terminal, wherein
the supporting tool is configured to be capable of supporting the portable information terminal at various tilt angles with the bag body in a state in which the portable information terminal is directly adhesive to the adhesion member.

2. The supporting tool for a portable information terminal according to claim 1, wherein
the adhesion member is made of a sucker member mounted to an outer surface of the bag body.

3. The supporting tool for a portable information terminal according to claim 1, wherein
the adhesion member is made of an antislip sheet material attached to an outer surface of the bag body.

4. The supporting tool for a portable information terminal according to claim 2, wherein
the portable information terminal is a cellular phone of a touch panel type, and
the bag body has a volume of 15 to 180 cm³.

5. The supporting tool for a portable information terminal according to claim 3, wherein
the portable information terminal is a tablet terminal of a touch panel type, and
the bag body has a volume of 180 to 4200 cm³.

6. The supporting tool for a portable information terminal according to claim 1, wherein
the bag body has a cleaning sheet material at a position opposite to the adhesion member.

7. The supporting tool for a portable information terminal according to claim 1, wherein
the bag body has an antislip member at a position opposite to the adhesion member.

8. The supporting tool for a portable information terminal according to claim 5, wherein
the bag body has four loop portions that are hooked to four corners of the tablet terminal.

9. The supporting tool for a portable information terminal according to claim 1, wherein
at least a side close to the adhesion member of the bag body is made of a stretchable cloth.
